(19) United States
(12) Patent Application Publication
(10) Pub. No.: US 2005/0216246 A1
(43) Pub. Date: Sep. 29, 2005

(54) Device characterization concept

(76) Inventor: Chee Hong Liau, Munchen (DE)

Correspondence Address: SLATER & MATSIL LLP, 17950 PRESTON ROAD, SUITE 1000, DALLAS, TX, 75252, US

(21) Appl. No.: 11/081,084

(22) Filed: Mar. 15, 2005

(30) Foreign Application Priority Data
Mar. 15, 2004 (EP) 04006074.1

(51) Int. Cl. G06F 17/50

(52) U.S. Cl. 703/14

(57) ABSTRACT

A device characterization concept to test a semiconductor design by simulation includes storing a defined pattern and defined pattern analysis length, an analysis time and a defined number of characterization design parameters as a list in a memory simulating a device under test (DUT). The design parameters are a function of different customer-like pattern and test conditions according to the equation characterize design parameters (randomize/optimize (input pattern, test condition)) by using a pattern and condition variation and optimization technique (PCVOT), so that the design parameters are a function of different customer-like pattern and test conditions and that the range of design parameters variation with respect to the different input pattern or condition or combination of them is analyzed until the worst case is detected.

This application claims priority to European Patent Application 04006074.1, which was filed Mar. 15, 2004, and is incorporated herein by reference.

### TECHNICAL FIELD

The invention concerns a device characterization concept to test a semiconductor design by simulation.

### BACKGROUND

In developing new semiconductor devices, several simulation processes are used to create a layout from the circuit that has been designed. A semiconductor device can then be fabricated from the layout using production steps such as deposition, photolithography, etching and so on. After generating a layout, it is necessary to check the design to verify that all given parameters or specifications are reached. Such a procedure is also necessary on customer developed circuits. To determine any weaknesses in design or trends in the manufacturing process, a general characterization concept is used to test the design.

A typical type of characterization concept is implemented by varying the design (e.g., test) parameters (e.g., timing, current, etc.) with respect to a pre-defined pattern and test condition, and determining where the part passes or fails.

Such a process is generally shown in FIG. 1 (prior art), which illustrates fail and pass areas for a given characterization test. The key to this process is detecting the trip point between the two areas as accurately as possible to ensure that the design meets all specifications. To achieve this goal, the design (test) parameters must be altered. There are various known methods for altering design (test) parameters to find the trip point of the device. These methods include linear, binary and successive approximation search methods. It seems to be clear that these methods are very time expensive.

However, there are many cases where several design parameters are measured and passed within the design specifications using typical characterization concepts, but these tests fail to detect the worst case behavior in real customer application site. This means that the customer could still see a specification violation during application testing. Therefore, a major technical problem and challenge is to determine the weakness in typical characterization concepts and how to overcome this weakness.

It is very difficult to determine if the characterization measurements are close to the worst case or far from it. This is because a typical characterization is based on only a small set of pre-defined patterns and test conditions and web tested in a very short time. Therefore, this process certainly cannot represent the potential worst case in real application.

For example, one design parameter value could change due to a different access sequence under a different condition and run time. Thus, a single access using one pre-defined pattern cannot accurately estimate whether the worst case has been meet or not. Moreover, there is no way to make a wild guess of what is the worst case pattern, since this pattern can be a very large random pattern (e.g., 2 million cycles). It is understood that this can only represent a short functional test.

In circumstances where the design parameters fail to detect the worst case, a very heavy effort in design analysis, such as by trial and error, is needed. Individual experiences are also needed. Moreover, it is very time consuming work to find out where and why the design parameters fail to meet specification.

The use of a typical characterization concept under the prior art leads to disadvantages. These typical characterization concepts use a small set of pre-defined patterns and test conditions as well as a short run time. Therefore, this process cannot represent the worst case in real application, since each characterization measurement is input pattern, test condition and run time dependent. Thus, the typical characterization concept cannot ensure that the worst case characterization is performed.

It should also be pointed out that the typical characterization concept cannot capture design parameter variations with respect to different input pattern sequences, test conditions or combinations of both. Furthermore, a very large random customer-like pattern is not practical for circuit simulation analysis.

Another problem is that many large random patterns can require an abundance of time in test program compiling, loading and executing and require a large amount of memory space.

Finally, all characterization results are based on individual test patterns and test conditions. Therefore, this method can only represent a very small portion of the functional verification. This method does not, however, imply that the design will not violate the specification if the customer uses other access sequences under different conditions. This shortcoming represents a major weakness in typical characterization concepts.

### SUMMARY OF THE INVENTION

In one aspect, embodiments of the invention define a pattern to estimate whether the worst case is met in a short time.

In a second aspect, embodiments of the invention determine if the design parameters meet the specification within a short time.

In a third aspect, embodiments of the invention provide a characterization concept that captures design parameter variations with respect to different input pattern sequences, or test conditions, or a combination of input pattern sequences and test conditions.

In a fourth aspect, embodiments of the invention reduce the time in test compiling, loading and executing and to reduce the necessary memory space.

The preferred embodiment discloses a device characterization concept to test a semiconductor design by simulation. This concept includes storing a defined pattern and defined pattern analysis length, an analysis time and defined number of characterization design parameters as a list in a memory simulating a device under test (DUT). The preferred embodiment is characterized by a multiple trip point characterization concept that produces different trip point values. In this embodiment, the worst case multiple point variation is analyzed and the trip point value is determined. The test is optimized for the worst case trip variation analysis. The design parameters are a function of different customer-like patterns and test conditions according the methodology:
characterize design parameters (randomize/optimize (input pattern, test condition));
using pattern and condition variation and optimization technique (PCVOT), so that the design parameters are a function of different customer-like pattern and test conditions; and
analyzing the range of design parameters variation with respect to the different input patterns or conditions or combinations of patterns and conditions until the worst case is detected.

### BRIEF DESCRIPTION OF THE DRAWINGS

The invention is described on some examples now. In the accompanying drawings are shown:

FIG. 1 illustrates a known trip point detection concept in device characterization;

FIG. 2 provides a flowchart of design parameter variation with pre-defined test condition;

FIG. 3 provides a flowchart of worst case design parameter analysis with a pre-defined test condition;

FIG. 4 provides a flowchart of a design parameter variation analysis with a random test condition;

FIG. 5 provides a flowchart of a worst case design parameter analysis with a random test condition;

FIG. 6 provides a general scheme of the multiple trip point concept in device characterization process; and

FIG. 7 provides experimental results demonstrating the excellent overview of design parameter variation range.

### DETAILED DESCRIPTION OF ILLUSTRATIVE EMBODIMENTS

Various embodiments of the present invention will now be disclosed with respect to specific examples. In particular, four variations of the invention will be explicitly described. To ensure that a characterization takes into account worst case design parameters, the first step would be to prepare a list of priority-one design parameters according to customer requirements. The list of design parameters can then be analyzed systematically using the four variations of the invention.

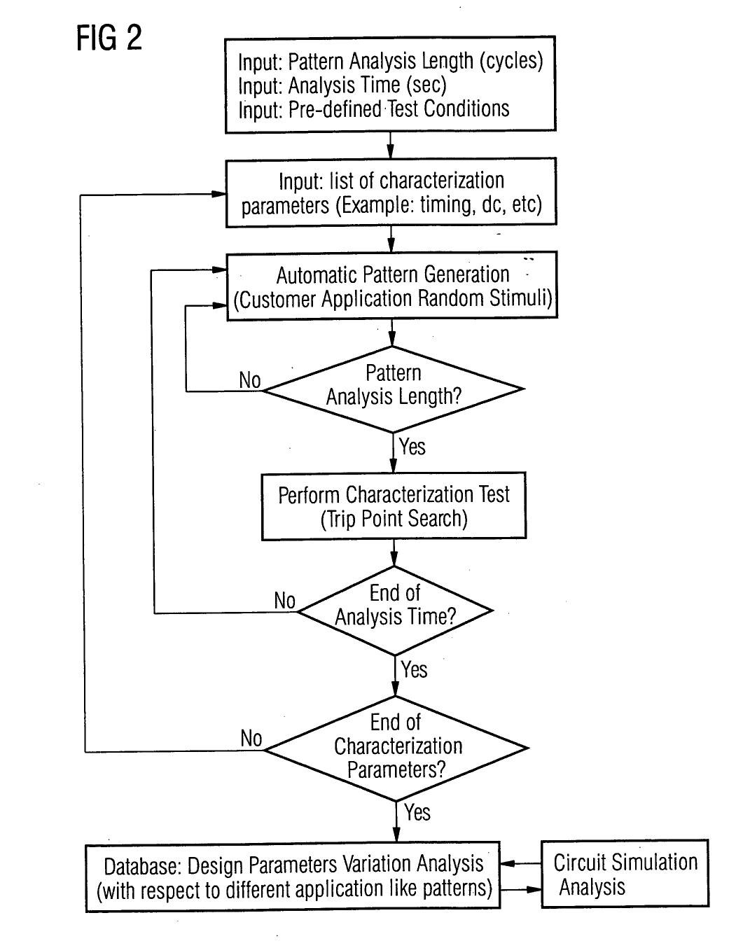

Referring now to FIG. 2, there is shown a first embodiment of the invention. This embodiment is useful to analyze design parameter variations with respect to application-like access with pre-defined application test conditions and a large run time.

The first embodiment can be explained with reference to the characterization of a memory integrated circuit, such as a dynamic random access memory (DRAM). In the example used to explain the embodiment, pre-defined data are characteristic read data valid time parameters. In one specific example, the pre-defined test condition can include: two core power supply levels, e.g., 1.8 V (normal) and 1.9 V (high). For a memory device, such as a DRAM, a TRC (device row cycle time) is 85 ns (refer to customer/application specification). A trip point search is from 100 ns to 7 ns and the analysis time is 30 minutes.

In this embodiment, the design characterization analysis steps are characterized as follows:
1. Define pattern analysis length (number of cycles), analysis time, pre-defined characterization (e.g., customer) test conditions.
2. Define a number of characterization design parameters in a list.
3. Automatically (e.g., randomly) generate a test pattern using ATE (Automatic Test Equipment) or any signal generator and measurement system.
4. Repeat step 3 until the pattern analysis length is reached (e.g., a trip point search at every 1000 cycles).
5. Apply a test pattern with the pre-defined characterization test conditions to a device under test (DUT).
6. Start the characterization test (trip point search) and store a trip point with respect to each input pattern.
7. Repeat steps 3 to 6 until the end of the analysis time.
8. Repeat steps 2 to 7 until the last of the characterization parameters is in the list.
9. Stop characterization of parameter variation analysis.
10. Analyze design parameters variation with minimum and maximum trip point patterns using ATE (including wafer probing internal signals) and circuit simulation. A variation that is too large implies a potential reduction problem and that the robustness of the design is weak. In other words, the design could likely be out of specification in real application tests. Otherwise, the design parameters are in specification.

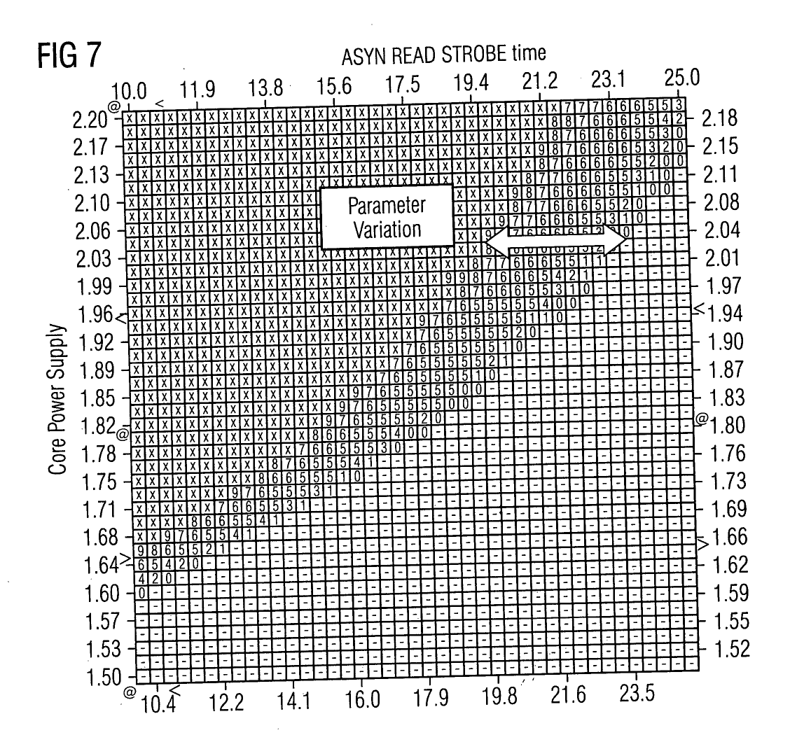

FIG. 7 demonstrates the result of such a test. This figure also demonstrates an excellent overview of design parameter variation ranges, each range value corresponding to a dedicated pattern sequence. This chart can used to localize design weaknesses. In this particular example, it is noted that the point where Vdd is 2.0 V (Y-axis) shows a much wider range of variation as compared with other Vdd values. One reason to explain this result is that the chip tends to run faster at a high Vdd, but also works when Vdd is 2.2 V. Such a large variation indicates potential design weaknesses and production yield issues.

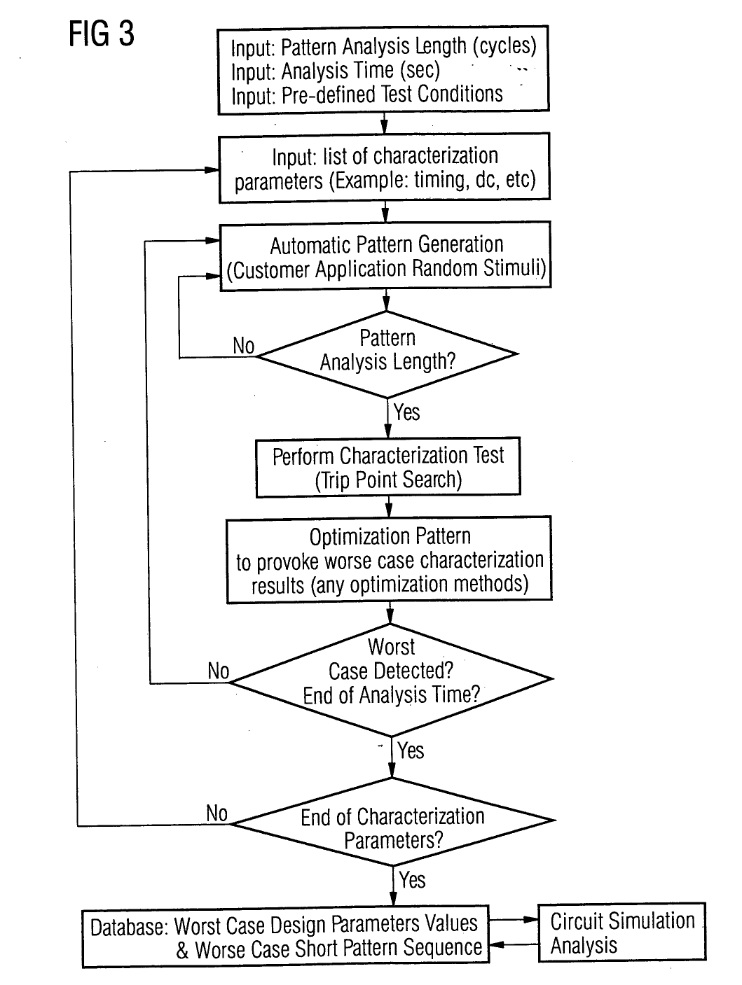

Referring now to FIG. 3, a second embodiment of the invention is shown. This embodiment is useful in analyzing worst case parameter values with respect to worst case applications such as access (optimization) with pre-defined application test conditions.

The second embodiment can also be described with respect to the characterization of a memory device. In one example, the characterize read data valid time parameter can be performed under pre-defined test conditions. For example, two core power supply levels of 1.8 V (norm) and 1.9 V (high) can be used. The TRC is 85 ns (refer to customer/application specification). The trip point search varies from 100 ns to 7 ns and the analysis time is 30 minutes.

The steps are characterized as follows:
1. Define a pattern analysis length (number of cycles), an analysis time, and pre-defined characterization (customer) test conditions.
2. Define a number of characterization design parameters in a list.
3. Automatically (e.g. randomly) generate a test pattern using ATE or any signal generator and measurement system.
4. Repeat step 3 until the pattern analysis length is reached (e.g., a trip point search at every 1000 cycles).
5. Apply the test pattern with the pre-defined characterization test conditions to a device under test (DUT).
6. Start the characterization test (e.g., trip point search) and store a trip point with respect to the input pattern.
7. Start trip point optimization with respect to input test pattern (any optimization methods).
8. Repeat steps 3 to 7 until a worst case is detected or the end of the analysis time is reached.
9. Repeat steps 3 to 8 until the last of the characterization parameters in the list has been used.
10. Stop the characterization of worst case parameter analysis.
11. Analyze and check if the worst case trip point is out of specification.
12. From step 10, extract the worst case pattern if the trip point is out of the margin of the specification using ATE (including wafer probing internal signals) and circuit simulation. This approach ensures that worst case characterization is performed.

The worst case pattern sequence can provoke the worst case characterization result. Without optimization, the worst case cannot be detected easily. Typical characterization methods of the prior art will not detect such a fault.

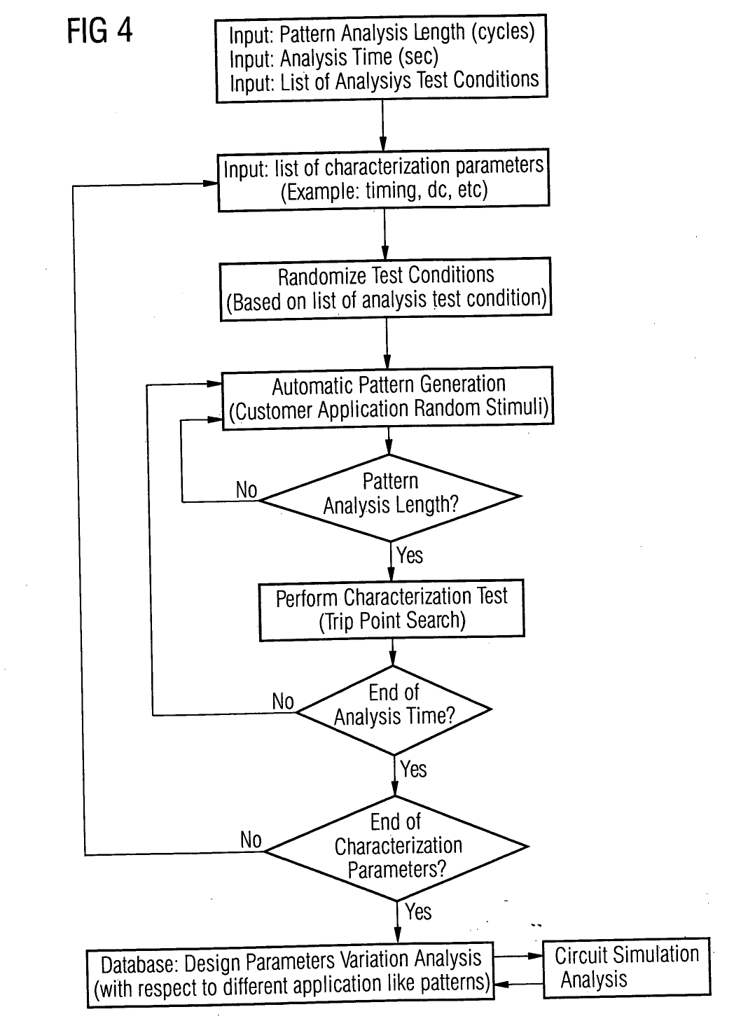

Referring now to FIG. 4, there is shown a third embodiment of the invention, which is useful in analyzing design parameter variation with respect to application-like access with test condition variation impact and large run time.

The steps are characterized as follows:
1. Define pattern analysis length (number of cycles), analysis time, and list of analysis (customer) test conditions.
2. Define a number of characterization design parameters.
3. Randomize test condition based on the list of analysis test conditions and their maximum and minimum specifications.
4. Automatically (e.g., randomly) generate a test pattern using ATE or any signal generator and measurement system.
5. Repeat step 4 until the pattern analysis length is reached (e.g., a trip point search at every 1000 cycles).
6. Apply a test pattern with random test condition variation to a device under test.
7. Start the characterization test (e.g., trip point search) and store the trip point with respect to input pattern and test variation set.
8. Repeat steps 3 to 7 until the end of the analysis time.
9. Repeat steps 2 to 8 until the last of the characterization parameters in the list has been tested.
10. Stop characterization of parameter variation analysis.
11. Analyze design parameters variation with minimum and maximum trip point.
12. Using the analysis from step 11, if the variation (maximum-minimum) is too large, extract the minimum and maximum trip point patterns and test condition variation set and analyze them using ATE (including wafer probing internal signals) and circuit simulation. A variation that is too large implies potential production problems and that the robustness of the design is weak. It is likely out of specification in real application test. Otherwise, the design parameters are in specification.

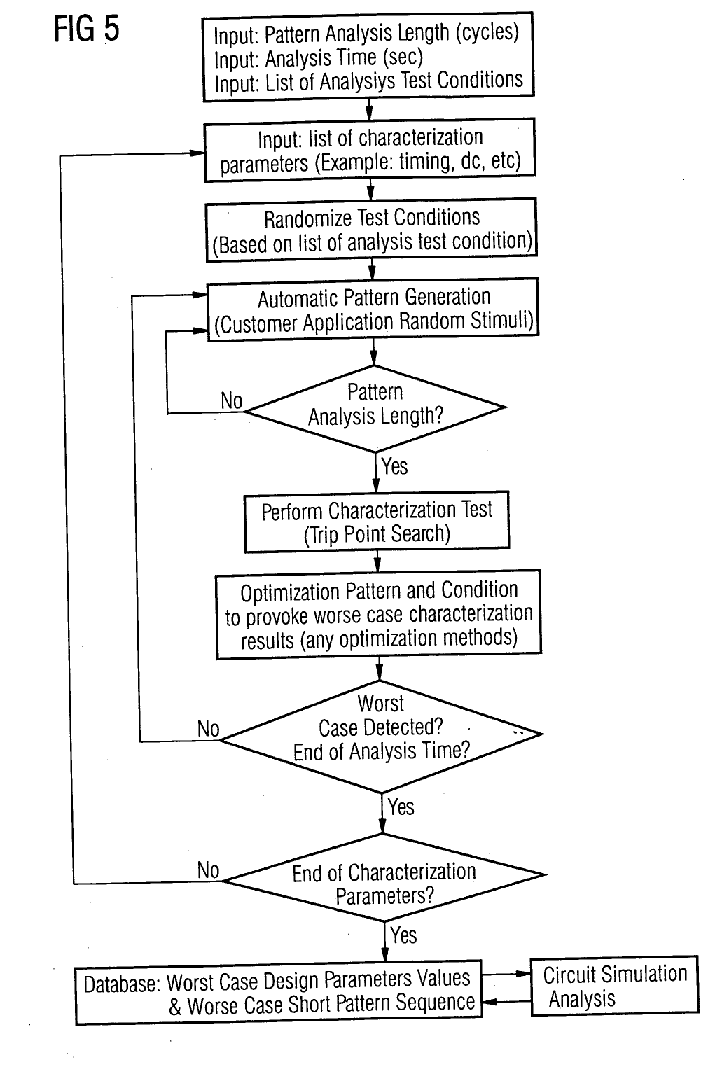

Referring now to FIG. 5, there is shown a fourth embodiment of the invention that is useful to analyze worse case parameter value with respect to worst case application-like access (optimization) with test condition variation impact.

The steps are characterized as follows:
1. Define a pattern analysis length (number of cycles), an analysis time, and a list of analysis (e.g., customer) test conditions.
2. Define a number of characterization design parameters.
3. Randomize test conditions based on the list of analysis test conditions and their maximum and minimum specifications.
4. Automatically (e.g., randomly) generate a test pattern using ATE or any signal generator and measurement system.
5. Repeat step 4 until the pattern analysis length is reached (e.g., a trip point search at every 1000 cycles).
6. Apply the test pattern with random test condition variations to a device under test.
7. Start a characterization test (trip point search) and store the trip point with respect to the input pattern and test condition variation set.
8. Start trip point optimization with respect to an input test pattern and test condition variation (any optimization methods).
9. Repeat steps 3 to 8 until the worst case is detected or the end of the analysis time.
10. Repeat steps 2 to 9 until the last of the characterization parameters in the list is tested.
11. Stop characterization of worse case parameter analysis.
12. Analyze and check if the worst case trip point is out of specifications.
13. From the analysis of step 12, extract the worse case pattern and test condition variation set if the trip point is out of margin of the specification using ATE (including wafer probing internal signals) and circuit simulation. This approach ensures that the worst case characterization is performed.

It is a great achievement with the help of optimization to detect a pattern sequence and test condition variation that can cause direct failure to the chip. This is especially true considering that the whole application will fail if the customer applies this access sequence and test condition set and the weakness was not already detected.

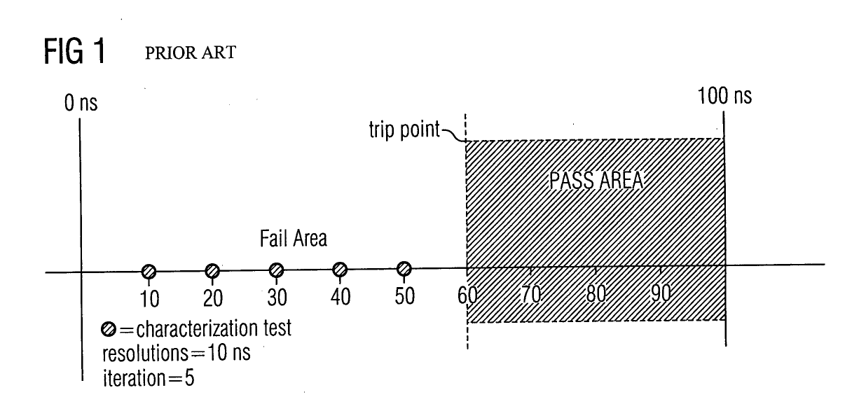

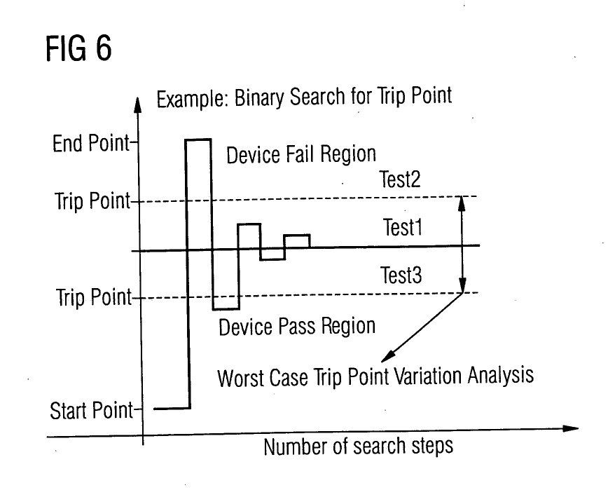

FIG. 6 shows the general scheme of the device characterization concept used to test a semiconductor design by the multiple trip point characterization concept, as opposed to a single trip point concept according the prior art as shown in FIG. 1. Tests 1, 2 and 3 in FIG. 6 produce different trip point values instead of looking at only one single trip point value (e.g. trip point=60 ns in FIG. 1).

The multiple trip point is determined by ATE measurement. The worst case multiple point variation analysis is analyzed by the four methods as described in FIGS. 2, 3, 4, and 5. The trip point value is determined by ATE measurement.

The test optimization in FIGS. 3 and 5 for the worst case trip point variation analysis can be based on any optimization and learning-adaptive methods, such as genetic algorithm, linear programming, neural network or fuzzy-expert system.

In the final phase, the detected worst case test can be analyzed in detail using ATE and simulation methods. At least, the whole process of the characterization concept is based on long running analysis methods, e.g., comprising defined pattern analysis length, an analysis time, and number of analysis design parameters as a list such that characterization is based on the theory that the design parameters are a function of different customer-like pattern and test conditions according to the following methodology:
characterize design parameters (randomize/optimize (input pattern, test condition)) by using pattern and condition variation and optimization technique (PCVOT), so that the design parameters are a function of different customer-like pattern and test conditions so that the range of design parameters variation with respect to the different input pattern or condition or combination of them is analyzed until the worst case is detected.

1. A method of characterizing a semiconductor design by simulation, the method comprising:
storing a defined pattern and defined pattern analysis length, an analysis time and a defined number of characterization design parameters as a list in a memory simulating a device under test (DUT);
analyzing a worst case multiple point variation;
determining a trip point value;
performing a worst case trip variation analysis, wherein design parameters are a function of different customer-like pattern and test conditions, the worst case trip point analysis being performed by:
characterizing design parameters;
using a pattern and condition variation and optimization technique (PCVOT), so that the design parameters are a function of different customer-like pattern and test conditions; and
analyzing a range of design parameter variation with respect to different input patterns, or conditions, or a combination of input patterns and conditions until the worst case point is detected.

2. The method according claim 1, wherein an automatic test pattern is generated using automatic test equipment (ATE), the automatic test pattern being used in the PCVOT.

3. The method according claim 1, wherein the trip point value is determined based on a short test sequence that includes about 50 to 1000 pattern cycles.

4. The method according claim 1, wherein a worst case trip point analysis comprises:
using an automatic test pattern generation;
repeating the test pattern generation until the pattern analysis length is reached;
applying the test pattern with pre-defined characterized test conditions to the DUT;
starting a characterization test for a trip point search using the determined trip point with respect to input pattern;
repeating the characterization test until the end of the analysis time and until the last of the characterization parameters in the list has been used;
analyzing design parameter variation with minimum and maximum trip points; and
if the variation is too large, extracting minimum and maximum trip point patterns using ATE and circuit simulation.

5. The method according claim 1, wherein performing a worst case trip point analysis comprises:
a) using an automatic test pattern generation and repeating the test pattern generation until the pattern analysis length is reached;
b) applying the test pattern with pre-defined characterized test condition to the DUT;
c) starting a characterization test for a trip point search using the determined trip point with respect to input pattern;
d) repeating the characterization until the end of the analysis time;
e) repeating steps a), b) and c) until the end of the characterization parameters in the list;
f) analyzing and checking if a worst case trip point is out of specification; and
g) extracting a worst case pattern if the worst case trip point is out of specification using ATE and circuit simulations.

6. The method according claim 1, wherein performing the worst case trip point analysis comprises:
using an automatic test pattern generation;
repeating the test pattern generation until the pattern analysis length is reached;
applying the test pattern with pre-defined characterized test conditions to the DUT;
starting a characterization test for a trip point search used to determine a trip point with respect to an input pattern and test condition variation set;
repeating the characterization test until a worst case is detected or the end of an analysis time is reached;
repeating the characterization test for all characterization parameters in the list;
analyzing design parameter variations with maximum and minimum trip points; and
if the variation is too large, extracting minimum and maximum trip point patterns and analyzing them using ATE and circuit simulation.

7. The method according claim 1, wherein performing a worst case trip point analysis comprises:
using an automatic test pattern generation;
repeating the test pattern generation until the pattern analysis length is reached;
applying the test pattern with pre-defined characterized test conditions to the DUT;
starting a characterization test for a trip point search used to determine the trip point with respect to input pattern and test condition variation set;
repeating the characterization step until the end of the analysis time;
repeating the characterization until all characterization parameters in the list are analyzed;
starting a trip point optimization with respect to input pattern and test condition variations and repeating the characterization steps until a worst case is detected or the end of analysis time is reached;
repeating the trip point optimization until last of the parameters in the list is used;
analyzing and checking if a worst case trip point is out of specification; and
if the worst case trip point is out of specification, extracting the worst case pattern and test condition variation set using ATE and circuit simulation.

8. The method according claim 1, wherein the characterization method is based on long running analysis methods, comprising defined pattern analysis length, an analysis time and number of analysis design parameters as a list.

9. A method of characterizing a semiconductor design, the method comprising:
performing a number of tests, each of the tests being performed with a different input pattern and/or a different test condition;
determining a number of trip points, each trip point being determined from results of one of the tests; and
analyzing the trip points to determine information relating to the robustness of the semiconductor design.

10. The method of claim 9 wherein the number of tests are performed using automatic test equipment.

11. The method of claim 9 wherein analyzing the trip points comprises determining a worst case trip point.

12. The method of claim 9 wherein performing a number of tests comprises performing tests based upon a short test sequence that includes about 50 to 1000 pattern cycles.

13. The method of claim 9 wherein analyzing the trip points comprises finding a maximum trip point and a minimum trip point.

14. The method of claim 13, further comprising indicating that the semiconductor design is sub par if a variation between the maximum trip point and the minimum trip point exceeds a value.

15. The method of claim 8 wherein analyzing the trip points comprises determining whether any of the trip points are out of specification.

16. A method of manufacturing a semiconductor device, the method comprising:
designing a circuit;
generating a layout based upon the circuit;
testing a device under test that utilizes the layout, the testing comprising:
performing a number of tests, each of the tests being performed with a different input pattern and/or a different test condition;
determining a number of trip points, each trip point being determined from results of one of the tests; and
analyzing the trip points to determine whether the device under test has passed the testing; and
if the device under test has passed the testing, manufacturing devices using the layout.

17. The method of claim 16 wherein analyzing the trip points comprises determining a worst case trip point and determining whether the worst case trip point is out of specification.

18. The method of claim 16 wherein performing a number of tests comprises performing tests based upon a short test sequence that includes about 50 to 1000 pattern cycles.

19. The method of claim 16 wherein analyzing the trip points comprises finding a maximum trip point and a minimum trip point.

20. The method of claim 19, wherein the device under test has passed the testing if a variation between the maximum trip point and the minimum trip point does not exceed a limit.
